(19) United States
(12) Patent Application Publication
(10) Pub. No.: US 2008/0147283 A1
(43) Pub. Date: Jun. 19, 2008

(54) Method for Controlling a Controllable Unit

(75) Inventors: Friedemann Jauch, Tettnang (DE); Franz-Josef Schuler, Kressbronn (DE); Michael Kiefer, Tettnang (DE); Eric Bosch, Friedrichshafen (DE)

Correspondence Address: DAVIS BUJOLD & Daniels, P.L.L.C., 112 PLEASANT STREET, CONCORD, NH, 03301, US

(73) Assignee: ZF FRIEDRICHSHAFEN AG, Friedrichshafen (DE)

(21) Appl. No.: 11/908,613

(22) PCT Filed: Mar. 15, 2006
(86) PCT No.: PCT/EP2006/002386

§ 371 Date: Dec. 28, 2007

(30) Foreign Application Priority Data
Mar. 17, 2005 (DE) 10 2005 012 255.8

(51) Int. Cl. G05B 13/02

(52) U.S. Cl. 701/51

(57) ABSTRACT

A method for the control of a controllable aggregate, in particular a transmission of a motor vehicle, in which to form at least one determinant magnitude various or varying numbers of contributions from delivery objects are taken into account, at least two different delivery objects being provided, by way of which respective contributions for the determination of the determinant magnitude are determined and such that a counter is provided, to which the contributions by all the delivery objects are sent. The counter evaluates each contribution by way of a weighting and sends it to an evaluating mechanism and this evaluating mechanism determines the determinant magnitude from the evaluated contributions. In addition, the invention concerns a control unit for the control of a controllable aggregate in accordance with such a method and an aggregate with such a control unit.

This application is a national stage completion of PCT/EP2006/002386 filed Mar. 15, 2006, which claims priority from German Application Serial No. 10 2005 012 255.8 filed Mar. 17, 2005.

### FIELD OF THE INVENTION

The invention concerns a method for the control of a controllable aggregate, in particular such as a transmission of a motor vehicle, such that to form at least one determinant magnitude various contributions or different numbers of contributions from delivery objects, are taken into account. In addition, the invention concerns a control unit for controlling such an aggregate and an aggregate of such type.

### BACKGROUND OF THE INVENTION

A method of the above-mentioned type is known from DE 198 14 483 A1. DE 198 14 483 A1 discloses a system for taking various numbers of contributions into account to form at least one determinant magnitude, in particular for controlling the operation of a motor vehicle. In this, the contributions from delivery objects are sent to an accumulator by way of which the determinant magnitude is formed as a function of the contributions sent. In addition, call-up/management means are provided by which sending the delivery object contributions to the accumulator is controlled. Thus, the call-up/management means decide from which delivery objects contributions are sent and which are not sent and, therefore, also not taken into account.

This has the disadvantage that only a limited number of contributions are sent, while contributions from non-active or not needed delivery objects are not sent and are, at least sometimes, not available for control purposes. This can create a situation such that, in the event of an evaluation change, certain necessary contributions are not available so that a modified evaluation cannot be applied directly by the control system, because contributions needed for this, from not yet active delivery objects, still first have to be supplied.

This prolongs the process overall and additional necessary process steps, such as the calling-up of delivery objects and sending of contributions, have to be implemented.

### SUMMARY OF THE INVENTION

The purpose of the present invention is to provide a method for controlling a controllable aggregate, in particular a motor vehicle transmission, which can be implemented quickly and reliably even after an evaluation change. A further purpose of the invention is to provide a control unit where such a method can be implemented and to provide such an aggregate.

According to the invention, this objective is achieved with a process, according to which, to form at least one determinant magnitude, various contributions or different numbers of contributions from delivery objects are taken into account, by virtue of which, in each case, a contribution for determining the determinant value is determined and a counter is provided, to which the contributions of all the delivery objects are sent, the counter assigning a value to each such contribution by weighting it and sending it to evaluation means which determine the determinant magnitude from the values of the contributions.

In an advantageous manner all the assigned values are continuously accessed so that, if the evaluation and the corresponding weighting change, these can be used by the control system of the aggregate immediately without the need of re-accessing new contributions. Thus, all the delivery objects are accessed and evaluated with the aid of a corresponding weighting and it is not the case as in the prior art mentioned that a management system decides which evaluations are disregarded and which are not, but rather the counter recognizes which evaluations are active. By way of an applicable table, the counter can then weight their value accordingly.

It is particularly advantageous to be able to assign priorities to individual evaluations relative to one another. If the evaluations for each application are prioritized then the current evaluation can be abandoned and a change is made to the active evaluation with the highest priority in the event that an evaluation with higher priority becomes active.

The method, according to the invention, is particularly suitable for controlling an automatic or automated transmission of a motor vehicle.

In this, the method offers advantages, particularly for the determination of a driver type, which will be taken into account for the selection of a driving mode or driving program. In a driver recognition process, a driving activity is computed from certain vehicle parameters, such as engine speed, pedal position, vehicle speed, transverse acceleration, longitudinal acceleration etc. This computation of driving activity by known methods, in most cases, is not easy since it is difficult to harmonize the various control parameters, present as characteristic values or performance characteristics, of the individual evaluation. Thus, when an individual evaluation is activated or deactivated, the other evaluations must be corrected since the newly determined driver type no longer corresponds to the driving style in question.

With this method, the driver type recognition can be considerably simplified.

### BRIEF DESCRIPTION OF THE DRAWINGS

The invention will now be described, by way of example, with reference to the accompanying drawings in which:

FIG. 1 is a schematic representation of a diagram showing the sequence of a method carried out according to the invention;

FIG. 2 is an evaluation matrix for implementing a method according to the invention, and

FIG. 3 is a schematic representation of a motor vehicle with a transmission that can be controlled in accordance with the invention, and a control unit designed for this.

### DETAILED DESCRIPTION OF THE INVENTION

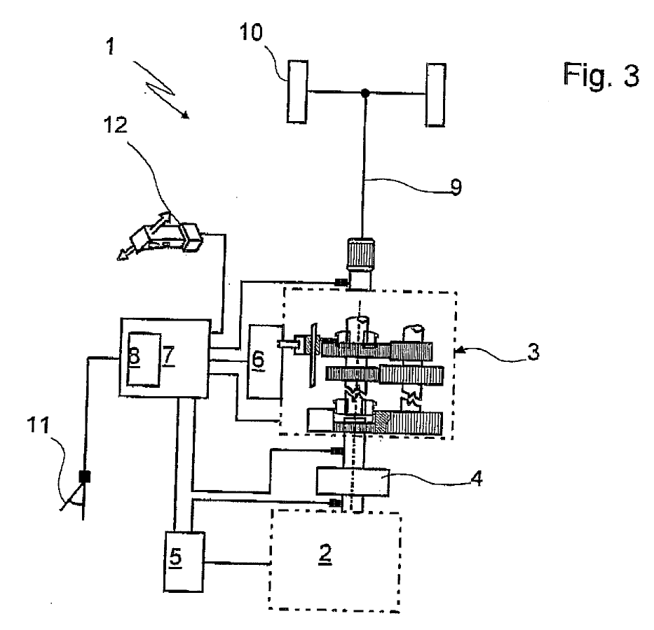

The method, according to the invention, for controlling an aggregate is explained, considering the example of the control of a transmission 3 of a motor vehicle 1, as illustrated in more detail in FIG. 3.

In an automatic transmission or an automated speed-shift transmission, shifts between gears are triggered when a characteristic gearshift curve is exceeded. In this, the gearshift curves are, as a rule, a function of a vehicle speed, the accelerator position and other parameters, if necessary.

A driving program contains all the necessary gearshift curves and, if necessary, also performance characteristics of the torque converter or clutch for a driving mode, such as a sporty driving mode, an economical driving mode or perhaps other driving modes, such as a winter driving program. By way of a selection element, the driver can choose between various driving modes directly or indirectly via driver-type recognition. It is also possible to adapt shift characteristics or gear change characteristics for a continuously variable transmission within a driving mode on the basis of driver-type recognition.

In addition, from various vehicle parameters that can be represented in the form of contributions from delivery objects, such as engine speed, accelerator position, vehicle speed, transverse acceleration and longitudinal acceleration, a driver activity is determined and a driver-type recognition is carried out. In this, such individual contributions or delivery objects can be activated or de-activated.

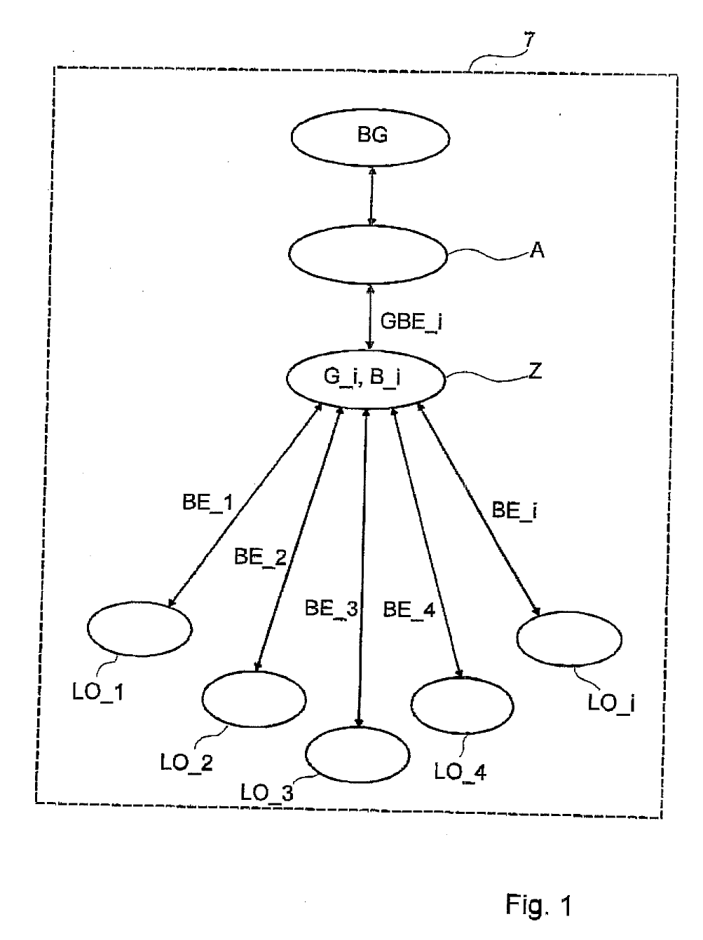

FIG. 1 shows a diagram for the implementation of a method in a control unit 7 of the transmission 3. Here, various delivery objects LO_1, LO_2 LO_3, LO_4 and LO_i are provided, each sending contributions BE_i with i=(1, 2, 3, 4 . . . ) to a counter Z. For this, for example the counter Z which in this case is a driver-type counter, accesses all the contributions BE_i from the delivery objects LO_i. These pass their contributions BE_i to the counter Z, which then processes the contributions.

In the present case, a first delivery object LO_1 carries out a start evaluation; a second delivery object LO_2 a kick-down evaluation; a third delivery object LO_3 a longitudinal acceleration evaluation, and a fourth delivery object LO_4 a transverse acceleration. Various additional delivery objects LO_i can be provided.

The start evaluation by delivery object LO_1 evaluates the starting process with reference to at least one magnitude, such as one of the parameters accelerator position, accelerator gradient and/or other parameters.

The kick-down evaluation by delivery object LO_2 evaluates a kick-down actuation of an accelerator with reference to at least one magnitude, such as an accelerator position, the passing of a predetermined accelerator position and/or other parameters.

The longitudinal acceleration evaluation by delivery object LO_3 evaluates the longitudinal acceleration of the vehicle and the transverse acceleration evaluation by delivery object LO_4 correspondingly evaluates the transverse acceleration of the vehicle.

The delivery objects deliver the contribution BE_i to the counter Z. The contributions BE_i can be accessed by the counter Z or can be sent directly by the delivery objects to the counter Z without being accessed.

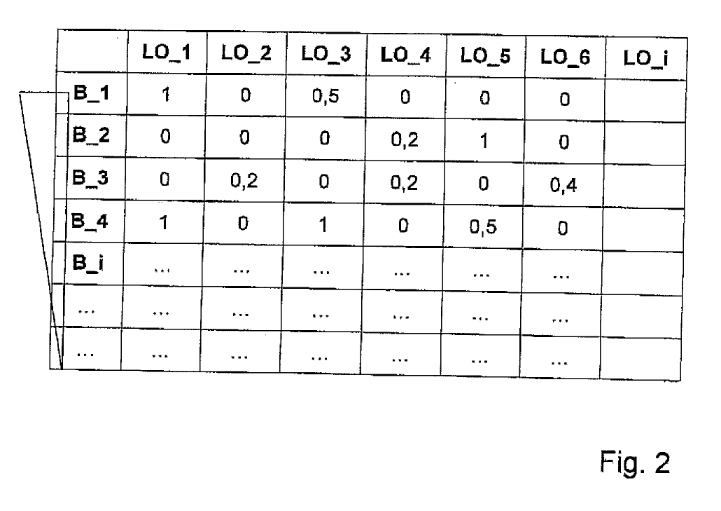

The counter Z weights the individual contributions BE_i from the delivery objects with a weighting G_i in accordance with the active evaluation B_i with the highest priority, as described below with reference to FIG. 2.

By way of the weighting G_i, weighted contributions GBE_i are produced from the contributions BE_i and, if necessary, these are processed further, for example summed together. These weighted contributions are sent to evaluating means A which determine a determinant magnitude BG from them. In the present context, the determinant magnitude BG is a driver-type recognition for the control of an automatic or automated transmission as the controllable aggregate, with reference to which a more sporty or more economical control mode of the transmission is adopted.

The evaluating means A which, in this case, cover a range of driver types, accesses the driver type counter Z object and processes the value delivered by the latter to produce the determinant magnitude, such as the driver type.

The more sporty transmission control mode, associated with a more sporty driver type, can be implemented by displacing shift characteristics to higher engine speeds so that a higher torque is available at higher engine speed. The more economical transmission control mode associated with a more economical driver type can be implemented by displacing shift characteristics to lower engine speeds, which makes for driving in a manner that reduces fuel consumption.

According to the invention, the counter Z receives the contributions from all the delivery objects and evaluates them with the weighting G_i, so that, in accordance with the evaluation carried out and prioritized, sometimes at least individual contributions received and available are not included in the determination of the determinant magnitude BG. In this, if there is a change in the prioritization of evaluations and possibly some evaluations are de-activated, other weighting factors and other contributions from other delivery objects can be used for determining the determinant magnitude. The contributions can be accessed by the counter according to priority.

Then, the contributions are weighted in accordance with an active evaluation and, as shown in FIG. 2, are taken into account in accordance with their weighting to determine the determinant magnitude BG. If an active evaluation is taken into account, the processing of other evaluations can be interrupted and the determination of the determinant magnitude BG by the evaluating unit A can continue.

FIG. 2 shows a matrix for use by the counter Z. In this, various evaluations B_i with their respective weightings G_i can be represented in the calculation matrix. The various evaluations B_i can be placed in sequence by prioritization so that the active evaluation B_i with highest priority in each case sets the weighting for determining the determinant magnitude.

Various cells are shown in the example embodiment of FIG. 2 in which, respectively, the evaluations B_1, B_2, B_3, B_4, etc. are represented. The delivery objects LO_i are assigned to the columns. The respective weighting factors G_i are entered in the matrix fields with which the contributions from the respective delivery objects will be weighted. For example, in a first line of evaluation B_1, the delivery object LO_1, i.e., the starting evaluation, is weighted with 100% and the delivery object LO_3 with 50%. The other delivery objects are weighted with 0 so that, in the evaluation B_1, they make no contribution towards determining the determinant magnitude.

If now the evaluation changes, because the evaluation B_1 has been de-activated, a change is made to the evaluation with the next-highest priority, for example to evaluation B_2. In the case of this evaluation B_2, the contribution from delivery object LO_4 has a weighting of 20% and the contribution BE_5 from delivery object LO_5 is weighted with 100%. The other delivery objects LO_i and their contributions BE_i are weighted with 0.

If now the evaluation B_2 is de-activated, a change can be made to the next evaluation. In the event that an evaluation with higher priority has been changed from the de-activated to the activated condition, the corresponding weightings of that evaluation could be used.

The advantage of the illustrated procedure is that the individual weighting of particular contributions can be effected with corresponding weighting factors, which can also be different for different evaluations.

It is also particularly advantageous that changes between evaluations can be carried out directly. For example, the longitudinal acceleration evaluation LO_3 can be exceeded by the transverse acceleration when driving round a curve so that, when driving round a curve is recognized, an evaluation for curve driving with changed weightings can be activated.

FIG. 3 schematically shows a motor vehicle 1 with a drive engine 2 and the transmission 3 as the controllable aggregate. The transmission 3 can be an automatic transmission, for example with a torque converter, or as shown in FIG. 3, an automated speed-shift transmission with a controllable clutch 4. The transmission can also be a dual clutch transmission or a continuously variable transmission.

As can also be seen in FIG. 3, the transmission 3 has the control unit 7 with storage and computing means 8 which, for controlling the transmission 3, is connected, among other things, to an accelerator pedal 11, a selector lever 12 that can be operated by a driver, an engine control unit 5 and various speed sensors for measuring the speeds of the engine, the transmission input shaft and the transmission output shaft.

The transmission 3 is actuated by an electro-hydraulic actuating unit 6 connected to the control unit 7. The output torque delivered by the transmission 3 is transmitted by a transmission output shaft 9 to driven wheels 10.

The contributions BE_i of the delivery objects LO-i are sent to the control unit 7, or produced internally on the basis of available data, so that they can be sent to the counter Z. The contributions can be measured by sensors or determined by other control units.

### REFERENCE NUMERALS

1 vehicle
2 drive engine
3 aggregate, such as a transmission
4 clutch
5 engine control unit
6 actuating unit
7 control unit
8 storage and computing means
9 transmission output shaft
10 driven wheels
11 accelerator pedal
12 selector lever
B_i evaluation i
BG determinant magnitude
BE_i contribution of delivery object i
LO_i delivery object i
Z counter
G_i weighting i
A evaluating means
GBE_i weighted contribution i

1-15. (canceled)

16. A method of controlling a transmission (3) of a motor vehicle (1) comprising the steps of:
requesting, with a counter (Z), information from each of a plurality of delivery objects (LO_i);
transmitting a contribution (BE_i) from each of the plurality of delivery objects (LO_i) to the counter (Z);
evaluating, in the counter (Z), each of the plurality of contributions (BE_i) by carrying out one of a plurality evaluations (B_i), each of the plurality of evaluations (B_i) has an individual weighting (G_i), the weighting (G_i) multiplies each of the plurality of contributions (BE_i) by a specific percentage which results in at least one evaluated contribution (GBE_i);
transmitting the at least one evaluated contribution (GBE_i) from the counter (Z) to an evaluating means (A); and
determining, in the evaluating means (A), at least one determinant magnitude (BG) on a basis of the at least one evaluated contributions (GBE_i).

17. The method according to claim 16, further comprising one of the steps of:
modifying, during the method, the one of the plurality evaluations (B_i); and
changing, during the method, the one of the plurality evaluations (B_i) to another of the plurality of evaluations (B_i).

18. The method according to claim 16, further comprising the step prioritizing the plurality of evaluations (B_i) with respect to one another.

19. The method according to claim 16, further comprising the step of deactivating at least one of the plurality of evaluations (B_i).

20. The method according to claim 19, further comprising the step of shifting the priority upon deactivation of an evaluation (B_i) with highest priority, at a point in time, to an active evaluation (B_i) which, after the deactivation of an evaluation (B_i), has a subsequent highest priority and is used for the weighting (G_i) of the plurality of contributions (BE_i).

21. The method according to claim 16, further comprising the step of defining each of a plurality of delivery objects (LO_1, LO_2, :O_3, LO_4, LO_i) as objects by which one of evaluations, data and signals concerning a current vehicle parameter are one of determined and obtained.

22. The method according to claim 21, further comprising the step of defining the vehicle parameter associated with the delivery object (LO_1, LO_2, LO_3, LO_4, LO_i) as a quantity selected from the group consisting of: an engine speed, an engine torque, a transmission speed, a transmission input shaft speed, a transmission output shaft speed, a wheel speed, a longitudinal vehicle speed, a transverse vehicle speed, a longitudinal vehicle acceleration, a transverse vehicle acceleration, a load lever position, a load lever actuation speed, a load lever actuation acceleration, a transmission selector lever setting, a transmission mode, a starting process and a kick-down status.

23. The method according to claim 16, further comprising the step of defining each of the plurality of contributions (BE_1, BE_2, BE_3, BE_4, BE_i) as a characteristic value representing a vehicle parameter.

24. The method according to claim 16, further comprising the step of defining the determinant magnitude (BG) as a driver type.

25. A control unit (7) for the control of a transmission (3) of a motor vehicle (1) comprising a storage means and a computing means (8) for implementing a method of controlling the transmission (3) comprising the steps of:
requesting, with a counter (Z), information from each of a plurality of delivery objects (LO_i);
transmitting a contribution (BE_i) from each of the plurality of delivery objects (LO_i) to the counter (Z);
evaluating, in the counter (Z), each of the plurality of contributions (BE_i) by carrying out one of a plurality evaluations (B_i), each of the plurality of evaluations (B_i) has an individual weighting (G_i), the weighting (G_i) multiplies each of the plurality of contributions (BE_i) by a specific percentage which results in at least one evaluated contribution (GBE_i);
transmitting the at least one evaluated contribution (GBE_i) from the counter (Z) to an evaluating means (A); and
determining, in the evaluating means (A), at least one determinant magnitude (BG) on a basis of the at least one evaluated contributions (GBE_i). according to claim 16.

26. An transmission (3) of a motor vehicle, with a control unit (7) for implementing a method controlling the transmission (3) comprising the steps of:
requesting, with a counter (Z), information from each of a plurality of delivery objects (LO_i);
transmitting a contribution (BE_i) from each of the plurality of delivery objects (LO_i) to the counter (Z);
evaluating, in the counter (Z), each of the plurality of contributions (BE_i) by carrying out one of a plurality evaluations (B_i), each of the plurality of evaluations (B_i) has an individual weighting (G_i), the weighting (G_i) multiplies each of the plurality of contributions (BE_i) by a specific percentage which results in at least one evaluated contribution (GBE_i );
transmitting the at least one evaluated contribution (GBE_i) from the counter (Z) to an evaluating means (A); and
determining, in the evaluating means (A), at least one determinant magnitude (BG) on a basis of the at least one evaluated contributions (GBE_i).
